(19) United States
(12) Patent Application Publication
(10) Pub. No.: US 2024/0117732 A1
(43) Pub. Date: Apr. 11, 2024

(54) WIRELESS MEASUREMENT WHILE DRILLING MODULE IN A DOWNHOLE TOOL

(71) Applicant: ERDOS MILLER, INC., Houston, TX (US)

(72) Inventors: Kenneth MILLER, Houston, TX (US); David ERDOS, Houston, TX (US); Abraham ERDOS, Houston, TX (US); Clayton CARTER, Houston, TX (US)

(73) Assignee: ERDOS MILLER, INC., Houston, TX (US)

(21) Appl. No.: 18/276,851

(22) PCT Filed: Feb. 23, 2022
(86) PCT No.: PCT/US2022/017452

§ 371 Date: Aug. 10, 2023

Related U.S. Application Data
(60) Provisional application No. 63/152,585, filed on Feb. 23, 2021.

(51) Int. Cl. E21B 47/13; E21B 47/017

(52) U.S. Cl. CPC E21B 47/13; E21B 47/017

(57) ABSTRACT

In some embodiments, a wireless MWD module is included in a MWD tool to enable communication between the MWD tool and a rig wireless module located at a rig surface. In some embodiments, a repeater is disposed at a drill collar to enable enhanced communication between the wireless MWD module in the MWD tool disposed within a borehole and the rig wireless module located at the rig surface.

### CROSS-REFERENCES TO RELATED APPLICATIONS

This application claims priority to U.S. Prov. Application No. 63/152,585, filed Feb. 23, 2021, titled “Wireless Measurement While Drilling Module in a Downhole Tool”, which is hereby incorporated by reference in its entirety for all purposes.

### TECHNICAL FIELD

This disclosure relates generally to wireless communication and, in particular, to a wireless measurement while drilling module in a downhole tool.

### BACKGROUND

One problem encountered in using a measurement while drilling (MWD) tool is that the MWD tool is pressure sealed, which prevents communicating with internal components (e.g., contact module, memory device, processing device, sensors, etc.) within the MWD tool. Typically, when the MWD tool is loaded or unloaded from a drill collar, the MWD tool is located at a rig surface for periods of time. Communicating with the internal components of the MWD tool may be desirable during those periods of time.

### SUMMARY

In one embodiment, a system is disclosed. The system includes a rig wireless module located at a rig surface; a wireless measurement while drilling (MWD) module disposed in an MWD tool located at the rig surface, wherein the wireless MWD module comprises: a transceiver comprising one or more antennas disposed on a printed circuit board coupled to a chassis; a housing enclosing the transceiver, wherein: the housing includes one or more slots adjacent to one or more sealing portions included in the housing, the one or more sealing portions support at least one or more portions of the transceiver within the housing, and the one or more antennas are configured to provide bidirectional wireless communication with the rig wireless module through the one or more sealing portions and the one or more slots in the housing.

In one embodiment, a method is disclosed. The method includes discovering, via a wireless measurement while (MWD) module connected to an MWD drilling tool, a rig wireless module when the wireless MWD module and the rig wireless module are within a threshold distance from each other, wherein the discovering is performed using a certain communication protocol; pairing with the rig wireless module to enable wireless communication; and transmitting, via one or more radios of the wireless MWD module, a wireless signal through a sealing portion supporting a chassis on which the one or more radios are disposed, wherein the wireless signal is transmitted through the sealing portion and a corresponding slot in a housing of the MWD tool.

In one embodiment, a system is disclosed. The system includes a drill collar; a rig wireless module configured to transmit and receive wireless signals; a measurement while drilling (MWD) tool comprising a wireless MWD module configured to transmit and receive the wireless signals, wherein the MWD tool is disposed within the drill collar; and a repeater positioned at a top of the drill collar, wherein: the repeater comprises at least a first antenna and a second antenna, the first antenna positioned away from an outside of the drill collar to transmit the wireless signals to the rig wireless module and to receive the wireless signals from the rig wireless module, and the second antenna is positioned toward an inside of the drill collar to transmit the wireless signals to the wireless MWD module and to receive the wireless signals from the wireless MWD module.

In one embodiment, a method is disclosed. The method includes receiving, at a first antenna of a repeater located at a top of a drill collar, a wireless signal from a wireless measurement while drilling (MWD) module included in an MWD tool disposed within the drill collar; transmitting, via a second antenna of the repeater located at the top of the drill collar, the wireless signal to a rig wireless module located at a rig surface; receiving, at the second antenna of the repeater located at the top of the drill collar, a second wireless signal from the rig wireless module located at the rig surface; and transmitting, via the first antenna of the repeater located at the top of the drill collar, the second wireless signal to the wireless MWD module included in the MWD tool disposed within the drill collar.

In one embodiment, a tangible, non-transitory computer-readable medium may store instructions that, when executed, cause a processing device to perform any of the methods, operations, and/or functions described herein.

In one embodiment, a system may include a memory device storing instructions, and a processing device communicatively coupled to the memory device. The processing device may execute the instructions to perform any of the methods, operations, and/or functions described herein.

Other technical features may be readily apparent to one skilled in the art from the following figures, descriptions, and claims. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

### BRIEF DESCRIPTION OF THE DRAWINGS

For a detailed description of example embodiments, reference will now be made to the accompanying drawings in which:

FIG. 1 illustrates a MWD data acquisition system as placed next to an oil rig. The MWD data acquisition system includes at least one data reception device according to certain embodiments of this disclosure;

FIG. 2 illustrates a block diagram of the MWD tool according to certain embodiments of this disclosure;

FIG. 3 a cut-away side view 300 of the wireless MWD module according to certain embodiments of this disclosure;

FIG. 4 illustrates an outside view of the housing including slots cut out of the housing to enable bidirectional wireless signal communication between the rig wireless module and the wireless MWD module according to certain embodiments of this disclosure;

FIG. 5 illustrates a block diagram illustrating the wireless MWD module and a rig wireless module in bidirectional wireless communication according to certain embodiments of this disclosure;

FIG. 6 illustrates a block diagram illustrating the MWD tool including the wireless MWD module lowered within the drill collar such that the wireless MWD module is below a top of the drill collar, and therefore unable to directly communicate a wireless signal to the rig wireless module according to certain embodiments of this disclosure;

FIG. 7 illustrates an example method for using a wireless MWD module to enable wireless communication between a wireless rig module and an MWD tool external to a drill collar according to certain embodiments of this disclosure;

FIG. 8 illustrates an example method—for using a repeater located at a top of a drill collar to enable wireless communication between a wireless MWD module and a rig wireless module when an MWD tool is disposed within the drill collar according to certain embodiments of this disclosure; and

FIG. 9 illustrates an example computer system which can perform any one or more of the methods, steps, or operations described herein according to certain embodiments of this disclosure.

### DETAILED DESCRIPTION

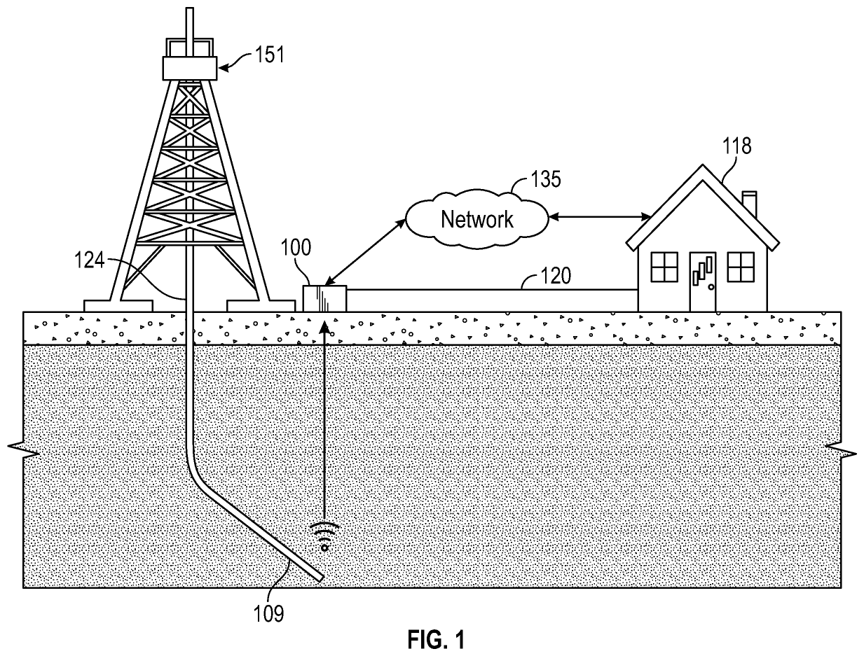

FIGS. 1 through 9, discussed below, and the various embodiments used to describe the principles of this disclosure are by way of illustration only and should not be construed in any way to limit the scope of the disclosure.

Systems and methods for using a wireless measurement while drilling module in a downhole tool are disclosed. The downhole tool may be a measurement while drilling (MWD) tool (e.g., retrievable via a spearpoint or may be non-retrievable). The MWD tool may include various sensors (e.g., pressure, temperature, vibration, azimuth, etc.) that perform measurements to obtain data, as well as various other electronic components (e.g., processor, memory, transceivers, buses, pulser, etc.).

FIG. 1 shows the MWD data acquisition system 100 as placed next to an oil rig. The MWD data acquisition system 100 includes at least one data reception device. In some embodiments, there may be more than one data reception device. The data reception device may include various components, such as an analog data reception circuit configured to receive analog MWD data from an MWD tool 109, an analog-to-digital conversion circuit configured to convert the analog MWD data to digital MWD data, a data transmission circuit configured to transmit analog and/or digital data to a surface computing device 118. In some embodiments, the surface computing device 118 may be local or remote from the MWD data acquisition system 100. For example, the MWD data acquisition system 100 may be locally communicatively connected, via a cable 120, to the surface computing device 118 or the MWD data acquisition system 100 may be remotely communicatively coupled, via a network 135, to the surface computing device 118. In some embodiments, the MWD data acquisition system 100 may be included as a component of the surface computing device 118. In some embodiments, the MWD data acquisition system 100 may include or be coupled to a component (e.g., pressure transducer) configured to receive the data sent from the MWD tool 109. In some embodiments, the MWD data acquisition system 100 is configured to transmit digital data to a surface computing device 118 via a network 135 and/or the cable 120 using, for example, one of the following cable and communication standards: RS-232, RS-422, RS-485, Ethernet, USB, or CAN bus. Network 135 may be a public network (e.g., connected to the Internet via wired (Ethernet) or wireless (WiFi)), a private network (e.g., a local area network (LAN) or wide area network (WAN)), or a combination thereof. Network 135 may also comprise a node or nodes on the Internet of Things (IoT).

The MWD tool 109 may be programmed with information such as which measurements to take and which data to transmit back to the surface. The MWD tool 109 may include a downhole processor. Communicating data between the downhole processor and a surface processor (e.g., included in the surface computing device 118) may be performed using various types of telemetry. For example, mud pulse (MP) telemetry and/or electromagnetic (EM) telemetry.

In some embodiments, a spearpoint may be mechanically and electrically coupled to the MWD tool 109. The spearpoint is made from material that is strong enough for lifting the spearpoint and the MWD tool 109 from the drill collar and for otherwise lifting the spearpoint and the MWD tool 109. In some embodiments, the spearpoint is made from one or more pieces of metal. In some embodiments, the spearpoint is made from one or more pieces of steel.

The spearpoint may be engaged by an over shot tool for lifting the spearpoint and the MWD tool 109, according to embodiments of the disclosure. The spearpoint is configured to be manipulated by a tool, such as a soft release tool, to lower the spearpoint on a cable into the collar and to release the spearpoint when the spearpoint has been placed into position. The over shot tool is used to engage the spearpoint to retrieve the spearpoint from the well borehole and bring the spearpoint to the surface. In embodiments, the over shot tool is used for lifting the spearpoint and the MWD tool 109 from the collar and/or for otherwise lifting the spearpoint and the MWD tool 109.

In some embodiments, the spearpoint may not include any external contacts that are capable of providing communication with the MWD tool 109. Instead, a wireless MWD module may be implemented below the spearpoint in a housing (e.g., pressure barrel) with the MWD tool 109, and the wireless MWD module may enable communications with the MWD tools 109. The spearpoint and the housing may be pressure sealed. The wireless MWD module may enable communicating with the MWD tool 109 without breaking the pressure seal. Further, the wireless MWD module may enable communicating with the MWD tool 109 when the MWD tool 109 is external to the drill collar, such as when the MWD tool 109 is located at the rig surface. For example, when the MWD tool 109 is disposed on a rig surface, the wireless MWD module may communicatively couple to a rig wireless module at the surface. The wireless MWD module may use a communication protocol (2.4 Gigahertz) to communicate with the rig wireless module. The 2.4 Gigahertz communication protocol may enable completely seamless operation where the rig wireless module and the wireless MWD module automatically discover each other and pair. The seamless operation may be low latency, robust, and reliable.

Such techniques are beneficial because they enable transmitting and receiving data to and from the MWD tool 109 without having to break the pressure seal. Typically, the MWD tool 109 is disposed on the rig surface for an extended period of time before being removed and processed to determine what data it collected while in the drill string. The wireless MWD module may automatically couple to the rig wireless module when in a certain distance from the rig wireless module and may transmit the data stored in the memory of the MWD tool 109 via the communication protocol. The data may include log data, sensor measurements from one or more sensors of the MWD tool 109, etc. Other functionality that is enabled by the wireless communication between the rig module and the wireless MWD module may include checking for live data, changing configurations of the MWD tool 109, downloading log files, etc. Further, the rig wireless module may receive the data and transmit the data a surface processor for analysis and decision making. The rig wireless module and the surface processor may be communicatively coupled via a network (e.g., wired (e.g., Ethernet) or wireless (e.g., WiFi, Local Area Network, Bluetooth, etc.)). The surface processor may transmit control instructions for the MWD tool 109 to the rig wireless module, and the rig wireless module may transmit the control instructions to the wireless MWD module. The wireless MWD module may receive the control instructions and transmit them to the MWD tool 109. A transceiver of the MWD tool 109 may receive the control instructions and transmit them, via a data path (e.g., bus, interface, etc.), to a processor. The processor may execute the control instructions. Executing the control instructions may configure an operating parameter (e.g., what sensor measurements to perform) of the MWD tool 109, reconfigure an operating parameter of the MWD tool 109, or the like.

The surface computing device 118 may be any suitable computing device, such as a laptop, tablet, smartphone, or computer. The surface computing device 118 may include a display capable of presenting a user interface of an application. The application may be implemented in computer instructions stored on the one or more memory devices of the surface computing device 118 and executable by the one or more processing devices of the surface computing device 118.

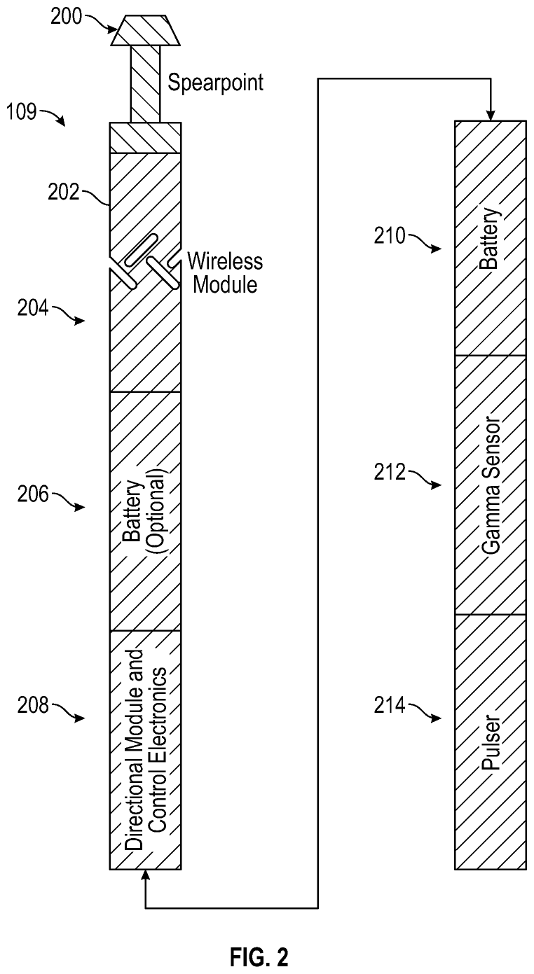

FIG. 2 is a block diagram of the MWD tool 109. As depicted, a spearpoint 200 is physically connected to the MWD tool 109. The spearpoint enables raising the MWD tool 109 from the drill collar and lowering the MWD tool 109 into the drill collar. The MWD tool 109 includes a pressure barrel configured to withstand a certain amount of pressure and to protect the internal components of the MWD tool 109. The MWD tool 109 includes a wireless MWD module 204 disposed directly beneath the spearpoint 200. Although the wireless MWD module 204 is shown as being located below the spearpoint 204 and is depicted as the top-most component in the MWD tool 109, the wireless MWD module 204 may be located at any suitable location within the MWD tool 109. The MWD tool 109 also includes an optional battery 206 that may be used to power any electronic component (e.g., the wireless MWD module 204) of the MWD tool 109. The MWD tool 109 also includes a directional module and control electronics 208 (e.g., processor, memory, transceiver, etc.). The wireless MWD module 204 may be communicatively connected to the directional module and control electronics 208 by any suitable means (e.g., wireless, wired, bus, interface, etc.). The wireless MWD module 204 may receive and/or obtain data from the memory of the directional module and control electronics 208 and transmit the data to the rig wireless module as disclosed herein. Further, the wireless MWD module 204 may receive data (e.g., control instructions) from the rig wireless module and transmit the data to the directional module and control electronics 208.

The MWD tool 109 may also include a battery 210 that is configured to power one or more of the electronic components of the MWD tool 109. The MWD tool 109 may also include one or more gamma sensors 212 configured to measure natural gamma ray values. The one or more gamma sensors 212 may be configured to take measurements through the drill collar. The measurements from the one or more gamma sensors 212 may be used for geosteering, correlation with existing open hole logs, identifying low and high radiation lithologies and depth correlation. In horizontal drilling, a gamma log may be used in identifying high gamma emitting shales. The MWD tool 109 may also include a pulser 214. In some embodiments, in the pulser 214, a battery powered on-board direct current electric motor may be used to operate a servo-valve, which in turn adjusts internal tool fluid pressures to cause operation of a main valve to substantially reduce mud flow to a drill bit, thereby creating a positive pressure pulse detectable at the surface.

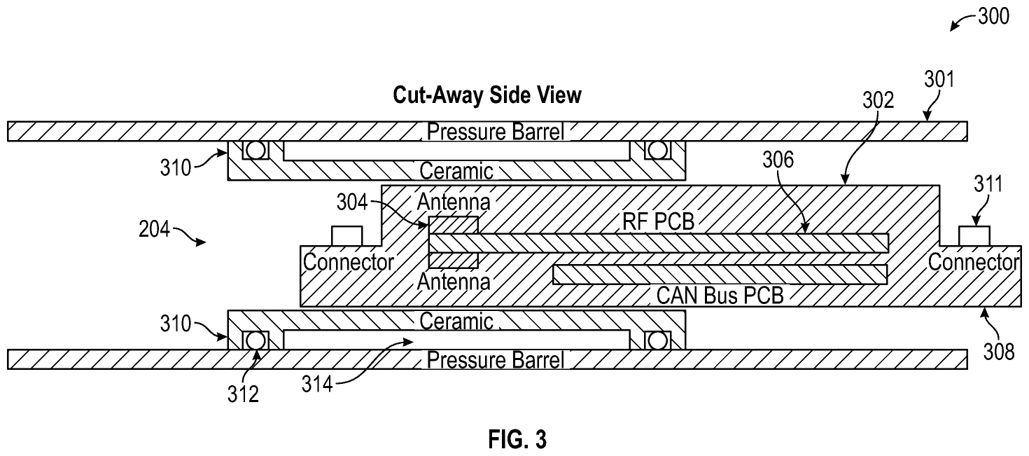

FIG. 3 is a cut-away side view 300 of the wireless MWD module 204. The wireless MWD module 204 may be disposed within a housing 301 (e.g., a pressure barrel made out of metal, steel, etc.). The wireless MWD module 204 may include a chassis 302 on which one or more electronic components are disposed. The one or more electronic components may include a certain number of antennas (e.g., 1, 2, 3, 4, 5, 6, etc.) 304. As depicted, two antennas 304 are disposed on and/or mounted on the chassis 302. The antennas 304 may be configured to transmit and receive wireless signals via radio frequency using a 2.4 Gigahertz communication protocol. For example, the antennas 304 may transmit wireless signals to the rig wireless module and receive wireless signals from the rig wireless module. The antennas 304 may be communicatively connected to a radio frequency printed circuit board (RF PCB) 306. The RF PCB 306 may be communicatively connected to a CAN bus PCB 308 (e.g., RS-485 CAN bus, qMIX, etc.) that is further communicatively connected to a connector 311. In some embodiments, the RF PCB 306 is directly communicatively connected to the connector 311. The connector 311 may be communicatively connected to the directional module and control electronics 208 to enable bidirectional communication between the wireless MWD module 204 and the directional module and control electronics 208.

As depicted, the chassis 302 is disposed between two sealing portions 310 disposed on the inside of the housing 301. Any suitable number of sealing portions 310 may be used. The sealing portions 310 may be configured to mount the chassis 302 between the sealing portions 310 and provide structure and stabilization to the chassis 302. In some embodiments, the sealing portions 310 may be configured to provide a pressure seal for the wireless MWD module 204 from pressure (e.g., approximately 20,000 psi) exerted from an external force on the housing 301. The sealing portions 310 may include one or more O-rings 312 to provide a seal against high pressure. The O-rings 312 may be elastomeric circular cross-section into a designed O-ring groove. Although not depicted in FIG. 3, there may be slots cut out of the housing 301 at locations corresponding to the sealing portions 310. The sealing portions 310 disposed at or in the slots of the housing 301 may be considered windows that enable communicating wireless signals between the antennas 304 and the rig wireless module.

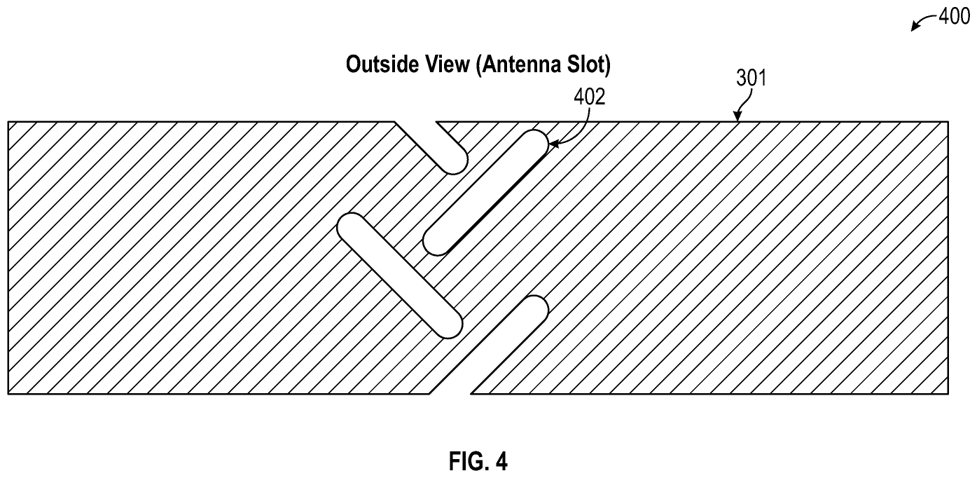

FIG. 4 is an outside view 400 of the housing 301 including slots 402 cut out of the housing 301 to enable bidirectional wireless signal communication between the rig wireless module and the wireless MWD module 204. The sealing portions 310 may be disposed inside the housing 301 (e.g., within, behind, or near the slots 402) to provide the pressure seal for the wireless MWD module 204 within the housing 301. Wireless signals may traverse the slots 301 due to the material of the sealing portions 310.

As depicted, the slots 402 are arranged in a particular “zigzag” pattern. The pattern may provide structural strength to the housing 301 against pressure exerted on the housing and also be configured to enhance a quality of the wireless signals transmitted and received by the wireless MWD module 204. It should be understood that there are other suitable patterns for the slots 402 that may be used that are within the scope of this disclosure. For example, a “perpendicular” pattern may be used for the slots 402.

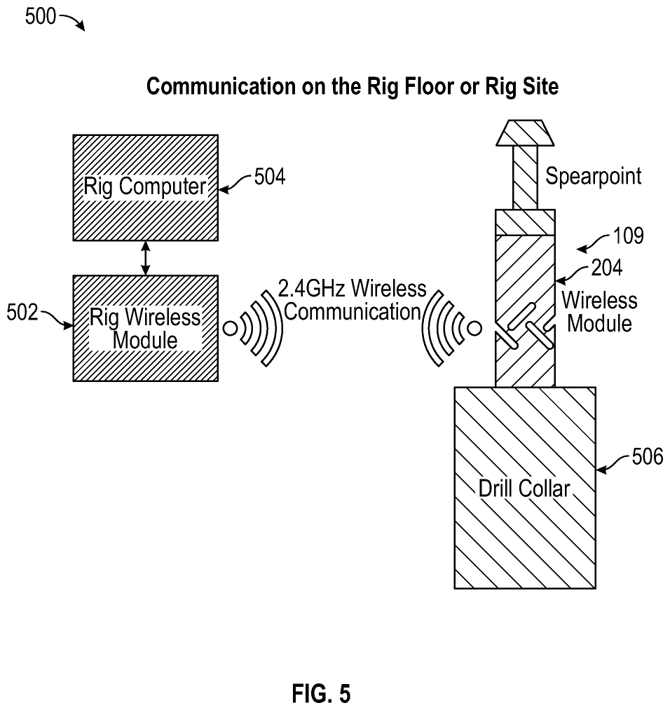

FIG. 5 is a block diagram 500 illustrating the wireless MWD module 204 and a rig wireless module 502 in bidirectional wireless communication. As previously discussed, the wireless MWD module 204 is included in the MWD tool 109. As depicted, the MWD tool 109 has been partially withdrawn from a drill collar 506. In some embodiments, when the wireless MWD module 204 is withdrawn from the drill collar 506 such that the antennas 304 are able to transmit and/or receive wireless signals, the wireless MWD module 204 may begin communicating with the rig wireless module 502. The rig wireless module 502 may include one or more transceivers, processors, and/or memories. As depicted, the rig wireless module 502 and the wireless MWD module 204 are communicating via 2.4 Gigahertz communication protocol. The rig wireless module 502 may receive wireless signals and transmit them to the rig computer (e.g., which includes one or more transceivers, processors, memories, etc.) for processing.

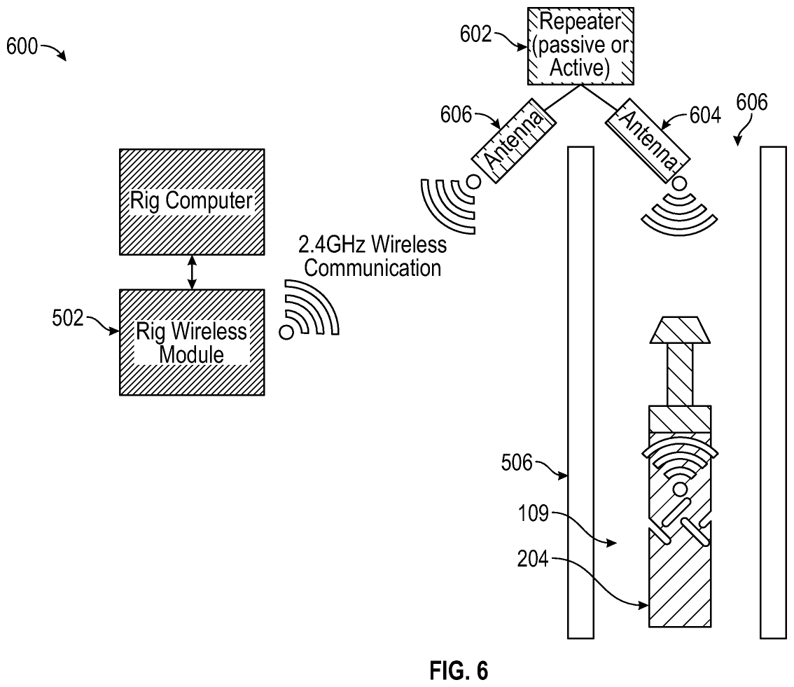

FIG. 6 is a block diagram 600 illustrating the MWD tool 109 including the wireless MWD module 204 lowered within the drill collar 506 such that the wireless MWD module 204 is below a top 606 of the drill collar 506, and therefore unable to directly communicate a wireless signal to the rig wireless module 502. Accordingly, a repeater 602 is disposed at or near the top 606 of the drill collar 506. In some embodiments, the repeater 602 may include a mechanical clamp mechanism that is configured to secure the repeater to a wall or edge of the top 606 of the drill collar 506. In some embodiments, the repeater 602 may be installed on a location of the rig that is above the top 606 of the drill collar 506 such a first antenna 604 is able to communicate wireless signals with the wireless MWD module 204.

The repeater 602 may be passive or active. A repeater may refer to an electronic device that receives a signal and retransmits it. Repeaters are used to extend transmissions so that the signal can cover longer distances or be received by a device on the other side of an obstruction. An active repeater may include an antenna or several antennas, a radio receiver, a radio transmitter, equipment for remote control of repeater operation, and/or a power supply. The active repeater may use solid-state devices. A passive repeater may be a reflective or refractive panel that assists in closing a radio or microwave link in places where an obstacle (e.g., drill collar 506) in the signal path blocks any direct, line of sight communication between the wireless MWD module 204 and the rig wireless module 502.

As depicted, an active repeater 602 is disposed at the top 606 of the drill collar 506. The active repeater 602 may include a first antenna 604 directed toward an inside of the drill collar 506 to enable bidirectional wireless communication with the wireless MWD module 204, and a second antenna 606 directed toward an outside of the drill collar 506 to enable bidirectional wireless communication with the rig wireless module 502. Using the antennas 604 and 606, bidirectional wireless communication between the wireless MWD module 204 and the rig wireless module 502 may be enabled while the MWD tool 109 is disposed within the drill collar 506.

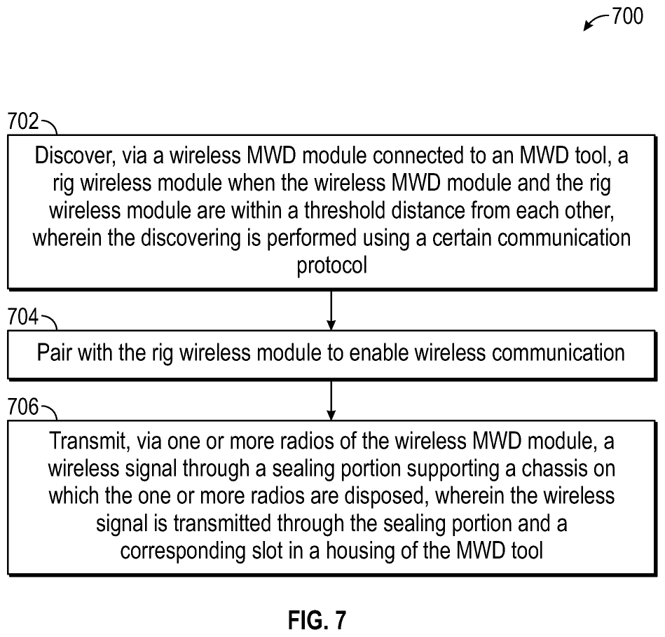

FIG. 7 is an example method 700 for using a wireless MWD module to enable wireless communication between a wireless rig module and an MWD tool external to a drill collar. One or more operations of the method may be performed by one or more components described herein (e.g., the wireless MWD module).

At operation 702, a rig wireless module may be discovered by a wireless MWD module connected to an MWD tool 109 when the wireless MWD module and the rig wireless module are within a threshold distance from each other. The discovery may be performed using a certain communication protocol (e.g., 2.4 Gigahertz).

At operation 704, the wireless MWD module may automatically pair with the rig wireless module to enable wireless communication between the wireless MWD module and the rig wireless module.

At operation 706, a wireless signal may be transmitted via one or more radios of the wireless MWD module through a sealing portion adjacent to at least a portion of a chassis on which the one or more radios are disposed. The wireless signal is transmitted through the sealing portion and a corresponding slot in a housing of the MWD tool 109. In some embodiments, the one or more radios may receive wireless signals through the slot and the sealing portion, where the wireless signals are transmitted from the rig wireless module. Such techniques enable bidirectional wireless communication between the rig wireless module and the wireless MWD module. The wireless MWD module may be communicatively connected to electronic components (e.g., transceiver, interface, processor, memory, etc.) of the MWD tool 109.

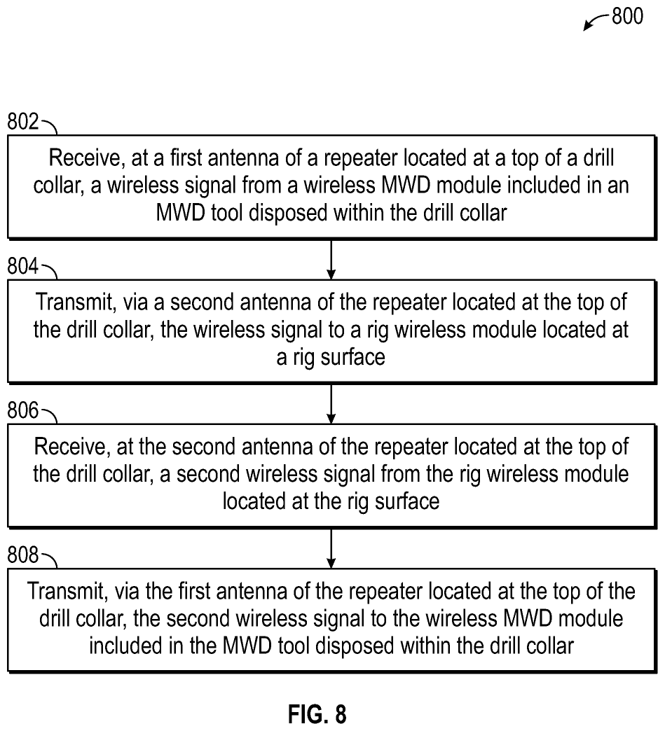

FIG. 8 is an example method 800 for using a repeater located at a top of a drill collar to enable wireless communication between a wireless MWD module and a rig wireless module when an MWD tool is disposed within the drill collar. One or more operations of the method may be performed by one or more components described herein (e.g., the repeater).

At operation 802, a wireless signal may be received at a first antenna of a repeater located at the top of the drill collar. The wireless signal may be received from a wireless MWD module included in an MWD tool disposed within the drill collar.

At operation 804, the wireless signal may be transmitted via a second antenna of the repeater located at the top of the drill collar. The wireless signal may be transmitted to the rig wireless module located at the rig surface.

At operation 806, a second wireless signal may be received at the second antenna of the repeater located at the top of the drill collar. The second wireless signal may be received from the rig wireless module located at the rig surface.

At operation 808, the second wireless signal may be transmitted via the first antenna of the repeater located at the top of the drill collar. The second wireless signal may be transmitted to the wireless MWD module included in the MWD tool disposed within the drill collar.

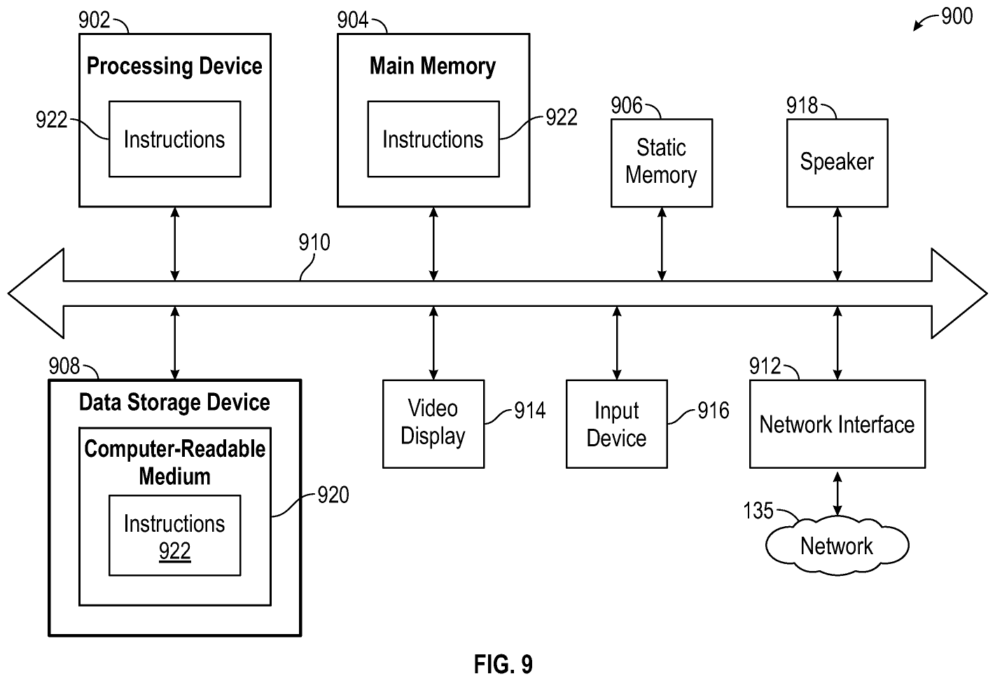

FIG. 9 shows an example computer system 900 which can perform any one or more of the methods, steps, or operations described herein, in accordance with one or more aspects of the present disclosure. In one example, computer system 900 may correspond to the wireless MWD module, the MWD tool, the rig wireless module, the rig computer, etc.

The computer system 900 includes a processing device 902, a main memory 904 (e.g., read-only memory (ROM), flash memory, solid state drives (SSDs), dynamic random access memory (DRAM) such as synchronous DRAM (SDRAM)), a static memory 906 (e.g., flash memory, solid state drives (SSDs), static random access memory (SRAM)), and a data storage device 908, which communicate with each other via a bus 910.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a system on a chip, a field programmable gate array (FPGA), a digital signal processor (DSP), network processor, or the like. The processing device 902 is configured to execute instructions for performing any of the operations and steps discussed herein.

The computer system 900 may further include a network interface device 912. The computer system 900 also may include a video display 914 (e.g., a liquid crystal display (LCD), a light-emitting diode (LED), an organic light-emitting diode (OLED), a quantum LED, a cathode ray tube (CRT), a shadow mask CRT, an aperture grille CRT, a monochrome CRT), one or more input devices 916 (e.g., a keyboard and/or a mouse), and one or more speakers 918 (e.g., a speaker). In one illustrative example, the video display 914 and the input device(s) 916 may be combined into a single component or device (e.g., an LCD touch screen).

The data storage device 916 may include a computer-readable medium 920 on which the instructions 922 embodying any one or more of the methods, operations, or functions described herein is stored. The instructions 922 may also reside, completely or at least partially, within the main memory 904 and/or within the processing device 902 during execution thereof by the computer system 900. As such, the main memory 904 and the processing device 902 also constitute computer-readable media. The instructions 922 may further be transmitted or received over a network 135 via the network interface device 912.

While the computer-readable storage medium 920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Consistent with the above disclosure, the examples of systems and method enumerated in the following clauses are specifically contemplated and are intended as a non-limiting set of examples.

### CLAUSES

1. A system comprising:
a rig wireless module located at a rig surface;
a wireless measurement while drilling (MWD) module disposed in an MWD tool located at the rig surface, wherein the wireless MWD module comprises:
a transceiver comprising one or more antennas mounted to a chassis;
a housing enclosing the transceiver, wherein:
the housing includes one or more slots adjacent to one or more sealing portions included in the housing,
the one or more sealing portions adjacent to at a least a portion of the chassis on which the antennas are mounted, and
the one or more antennas are configured to provide bidirectional wireless communication with the rig wireless module through the one or more sealing portions and the one or more slots in the housing.

2. The system of any clause herein, wherein the one or more antennas are disposed on a printed circuit board mounted to the chassis.

3. The system of any clause herein, wherein the wireless MWD module discovers the rig wireless module when the rig wireless module and the wireless MWD module are within a threshold distance from each other.

4. The system of any clause herein, wherein a communication protocol is used to perform the discovering.

5. The system of any clause herein, wherein the wireless MWD module pairs with the rig wireless module to enable the wireless bidirectional communication with the rig wireless module.

6. The system of any clause herein, further comprising a repeater disposed at a top of a drill collar, wherein the repeater is configured to transmit wireless signals from the wireless MWD module to the rig wireless module.

7. A method comprising:
discovering, via a wireless measurement while (MWD) module connected to an MWD drilling tool, a rig wireless module when the wireless MWD module and the rig wireless module are within a threshold distance from each other, wherein the discovering is performed using a certain communication protocol;
pairing with the rig wireless module to enable wireless communication; and
transmitting, via one or more radios of the wireless MWD module, a wireless signal through a sealing portion adjacent to at least a portion of a chassis on which the one or more radios are disposed, wherein the wireless signal is transmitted through the sealing portion and a corresponding slot in a housing of the MWD tool.

8. The method of any clause herein, wherein the certain communication protocol comprises a 2.4 Gigahertz communication protocol.

9. The method of any clause herein, further comprising another wireless signal to a repeater disposed at a top of a drill collar in which the MWD tool is disposed in.

10. The method of any clause herein, wherein the repeater comprises a first antenna configured to receive the another wireless signal and a second antenna configured to transmit the another wireless signal to the rig wireless module.

11. The method of any clause herein, wherein the MWD tool is located outside of a drill collar.

12. The method of any clause herein, wherein the repeater comprises an active repeater.

13. The method of any clause herein, wherein the repeater is secured to the top of the drill collar via a mechanical clamp mechanism.

14. A system comprising:
a drill collar;
a rig wireless module configured to transmit and receive wireless signals;
a measurement while drilling (MWD) tool comprising a wireless MWD module configured to transmit and receive the wireless signals, wherein the MWD tool is disposed within the drill collar; and
a repeater positioned at a top of the drill collar, wherein:
the repeater comprises at least a first antenna and a second antenna,
the first antenna positioned away from an outside of the drill collar to transmit the wireless signals to the rig wireless module and to receive the wireless signals from the rig wireless module, and
the second antenna is positioned toward an inside of the drill collar to transmit the wireless signals to the wireless MWD module and to receive the wireless signals from the wireless MWD module.

15. The system of any clause herein, wherein the repeater is secured to the drill collar using a mechanical clamp mechanism.

16. The system of any clause herein, wherein the wireless MWD module and the rig wireless module are configured to discover each other when within a threshold distance from each other.

17. The system of any clause herein, wherein the wireless MWD module and the rig wireless module are configured to pair with each other after discovery.

18. The system of any clause herein, wherein a 2.4 Gigahertz communication protocol is used during discovery.

19. The system of any clause herein, wherein the repeater is an active repeater.

20. The system of any clause herein, wherein the wireless MWD module and the rig wireless module are configured to automatically pair and transmit data when the MWD tool is located on a rig floor and the wireless MWD module and the rig wireless module are within a threshold distance from each other.

21. A method comprising:
receiving, at a first antenna of a repeater located at a top of a drill collar, a wireless signal from a wireless measurement while drilling (MWD) module included in an MWD tool disposed within the drill collar;
transmitting, via a second antenna of the repeater located at the top of the drill collar, the wireless signal to a rig wireless module located at a rig surface;
receiving, at the second antenna of the repeater located at the top of the drill collar, a second wireless signal from the rig wireless module located at the rig surface; and
transmitting, via the first antenna of the repeater located at the top of the drill collar, the second wireless signal to the wireless MWD module included in the MWD tool disposed within the drill collar.

1. A system comprising:
a rig wireless module located at a rig surface;
a wireless measurement while drilling (MWD) module disposed in an MWD tool located at the rig surface, wherein the wireless MWD module comprises:
a transceiver comprising one or more antennas mounted to a chassis;
a housing enclosing the transceiver, wherein:
the housing includes one or more slots adjacent to one or more sealing portions included in the housing,
the one or more sealing portions adjacent to at least a portion of the chassis on which the antennas are mounted, and
the one or more antennas are configured to provide bidirectional wireless communication with the rig wireless module through the one or more sealing portions and the one or more slots in the housing.

2. The system of claim 1, wherein the one or more antennas are disposed on a printed circuit board mounted to the chassis.

3. The system of claim 1, wherein the wireless MWD module discovers the rig wireless module when the rig wireless module and the wireless MWD module are within a threshold distance from each other.

4. The system of claim 1, wherein a communication protocol is used to perform the discovering.

5. The system of claim 1, wherein the wireless MWD module pairs with the rig wireless module to enable the wireless bidirectional communication with the rig wireless module.

6. The system of claim 1, further comprising a repeater disposed at a top of a drill collar, wherein the repeater is configured to transmit wireless signals from the wireless MWD module to the rig wireless module.

7. A method comprising:
discovering, via a wireless measurement while (MWD) module connected to an MWD drilling tool, a rig wireless module when the wireless MWD module and the rig wireless module are within a threshold distance from each other, wherein the discovering is performed using a certain communication protocol;
pairing with the rig wireless module to enable wireless communication; and
transmitting, via one or more radios of the wireless MWD module, a wireless signal through a sealing portion adjacent to at least a portion of a chassis on which the one or more radios are disposed, wherein the wireless signal is transmitted through the sealing portion and a corresponding slot in a housing of the MWD tool.

8. The method of claim 7, wherein the certain communication protocol comprises a 2.4 Gigahertz communication protocol.

9. The method of claim 7, further comprising another wireless signal to a repeater disposed at a top of a drill collar in which the MWD tool is disposed in.

10. The method of claim 9, wherein the repeater comprises a first antenna configured to receive the another wireless signal and a second antenna configured to transmit the other wireless signal to the rig wireless module.

11. The method of claim 7, wherein the MWD tool is located outside of a drill collar.

12. The method of claim 7, wherein the repeater comprises an active repeater.

13. The method of claim 9, wherein the repeater is secured to the top of the drill collar via a mechanical clamp mechanism.

14. A system comprising:
a drill collar;
a rig wireless module configured to transmit and receive wireless signals;
a measurement while drilling (MWD) tool comprising a wireless MWD module configured to transmit and receive the wireless signals, wherein the MWD tool is disposed within the drill collar; and
a repeater positioned at a top of the drill collar, wherein:
the repeater comprises at least a first antenna and a second antenna,
the first antenna positioned away from an outside of the drill collar to transmit the wireless signals to the rig wireless module and to receive the wireless signals from the rig wireless module, and
the second antenna is positioned toward an inside of the drill collar to transmit the wireless signals to the wireless MWD module and to receive the wireless signals from the wireless MWD module.

15. The system of claim 14, wherein the repeater is secured to the drill collar using a mechanical clamp mechanism.

16. The system of claim 14, wherein the wireless MWD module and the rig wireless module are configured to discover each other when within a threshold distance from each other.

17. The system of claim 16, wherein the wireless MWD module and the rig wireless module are configured to pair with each other after discovery.

18. The system of claim 16, wherein a 2.4 Gigahertz communication protocol is used during discovery.

19. The system of claim 16, wherein the repeater is an active repeater.

20. The system of claim 14, wherein the wireless MWD module and the rig wireless module are configured to automatically pair and transmit data when the MWD tool is located on a rig floor and the wireless MWD module and the rig wireless module are within a threshold distance from each other.

21. A method comprising:
receiving, at a first antenna of a repeater located at a top of a drill collar, a wireless signal from a wireless measurement while drilling (MWD) module included in an MWD tool disposed within the drill collar;
transmitting, via a second antenna of the repeater located at the top of the drill collar, the wireless signal to a rig wireless module located at a rig surface;
receiving, at the second antenna of the repeater located at the top of the drill collar, a second wireless signal from the rig wireless module located at the rig surface; and
transmitting, via the first antenna of the repeater located at the top of the drill collar, the second wireless signal to the wireless MWD module included in the MWD tool disposed within the drill collar.
